(19) United States
(12) Patent Application Publication
(10) Pub. No.: US 2020/0259406 A1
(43) Pub. Date: Aug. 13, 2020

(54) STACKED ACTUATOR SYSTEM

(71) Applicant: Systems, Machines, Automation Components Corporation, Carlsbad, CA (US)

(72) Inventors: Edward A. Neff, Carlsbad, CA (US); Toan Vu, Carlsbad, CA (US); Mark Cato, Carlsbad, CA (US); Reyhan Zanis, Carlsbad, CA (US)

(21) Appl. No.: 16/785,488

(22) Filed: Feb. 7, 2020

Related U.S. Application Data
(60) Provisional application No. 62/802,651, filed on Feb. 7, 2019.
(60) Provisional application No. 62/971,848, filed on Feb. 7, 2020.

(51) Int. Cl. H02K 41/03; H02K 3/26; H02K 5/22

(52) U.S. Cl. CPC H02K 41/031; H02K 5/225; H02K 3/26

(57) ABSTRACT

A stacked actuator system including a plurality of electromagnetic actuators operative to drive a piston shaft between extended and retracted positions. A plurality of electrical connectors and a plurality of signal lines are connected between the plurality of electromagnetic actuators and the plurality of electrical connectors. A system housing at least partially defines an interior volume containing the plurality of electromagnetic actuators. The system housing includes a plurality of apertures through which extends the piston shaft of each of the plurality of electromagnetic actuators. A controller is disposed within the interior volume and connected to the plurality of electrical connectors. The stacked actuator system may further include a base platform element upon which are mounted the plurality of electromagnetic actuators and the system housing. Each piston shaft may move between extended and retracted positions within a plane substantially parallel to the base platform element.

### CROSS-REFERENCE TO RELATED APPLICATIONS

This application claims the benefit of priority under 35 USC § 119(e) of U.S. Provisional Application No. 62/802,651, entitled STACKED ACTUATOR SYSTEM, filed Feb. 7, 2019, and of U.S. Provisional Application No. 62/971,848, entitled ACTUATOR SYSTEM INCLUDING VARIABLE-PITCH PRINTED COILS, filed Feb. 7, 2020, the contents of each of which are incorporated herein by reference in their entirety for all purposes.

### FIELD

This disclosure relates generally to electromagnetic actuators and, more particularly, to linear electromagnetic actuators having moving coils.

### BACKGROUND

Linear electromagnetic actuators are mechanical devices which are used to perform repetitive actions requiring linear motion. For example, linear electromagnetic actuators can be used in an assembly plant for placing caps on bottles, for automatically stamping or labeling mail, for glass cutting, for placing electronic components on printed circuit boards, for testing various buttons or touch areas on electronic devices, for automation, and for a wide variety of other purposes as well.

In plants designed to assemble electronic devices, electromagnetic actuators are used to, for example, pick up and move components provided by a parts feeder or similar apparatus. In modern printed circuit board assembly lines, the center points of the smallest parts feeder stations are separated by a distance, or pitch, of slightly less than 8 mm. Thus, in order for two electromagnetic actuators to be paired with two adjacent part feeder stations arranged at an 8 mm pitch, each of the electromagnetic actuators must have a diameter of less than 8 mm in order to enable components to be retrieved from the adjacent parts feeders and properly placed upon on circuit boards.

Typically, enterprises involved in the electronic assembly of devices comprised of small parts utilize pneumatic electromagnetic actuators, or “slides”, to manipulate such parts. Although pneumatic slides are generally inexpensive, the component parts used in, for example, various electronic or industrial devices can be so small and fragile that compressed air pneumatic slides may cause damage when placing such parts on a circuit board due to the friction forces that must be overcome to achieve actuation in typical compressed air pneumatic slides. Further, pneumatic slides are known to have a somewhat limited lifetime, and may sometimes last less than 10M cycles.

In contrast, magnetic electromagnetic actuators typically enjoy a longer lifetime than pneumatic slides. In addition, magnetic electromagnetic actuators can be designed to “soft-land” and control the applied force, thereby reducing the risk of part breakage. Examples of such electromagnetic actuators can be found in U.S. Pat. No. 5,952,589 entitled “Soft Landing Method For Probe Assembly,” assigned to the assignee of the present application and incorporated by reference herein in its entirety. However, magnetic electromagnetic actuators may generate significant amounts of heat. Heating can be reduced by lowering either the current through the actuator coils or the strength of the magnetic field. Unfortunately, adopting either of these approaches limits the maximum applied force and/or acceleration of the actuator.

### SUMMARY

Disclosed herein is a stacked actuator system including a plurality of electromagnetic actuators, each of which is operative to drive a piston shaft between extended and retracted positions. The stacked actuator system further includes a plurality of electrical connectors and a plurality of signal lines connected between the plurality of electromagnetic actuators and the plurality of electrical connectors. A system housing at least partially defines an interior volume containing the plurality of electromagnetic actuators. The system housing includes a plurality of apertures through which extends the piston shaft of each of the plurality of electromagnetic actuators. A controller is disposed within the interior volume and connected to the plurality of electrical connectors. The stacked actuator system may further include a base platform element upon which are mounted the plurality of electromagnetic actuators and the system housing.

Each piston shaft may be disposed to move between extended and retracted positions within a plane substantially parallel to a generally planar surface of the base platform element.

The plurality of connectors may be disposed on the base platform element between the plurality of electromagnetic actuators and the controller.

Each piston shaft may comprise a vacuum shaft, where each of the plurality of electromagnetic actuators includes a thru shaft vacuum fitting defining an aperture in communication with an interior of the vacuum shaft of the actuator.

In one implementation each of the plurality of electromagnetic actuators includes:

an actuator housing including a first planar plate, a second planar plate and a plurality of side members attached to the first plate and the second planar plate;

a first plurality of magnets secured to the first planar plate;

a second plurality of magnets secured to the second planar plate.

Each of the plurality electromagnetic actuators may further include a piston assembly positioned at least partially within the actuator housing. The piston assembly preferably includes:
the piston shaft of the at least one of the plurality of electromagnetic actuators,
an arrangement of coils wherein ones of the coils are positioned between the first plurality of magnets and the second plurality of magnets during operation of the at least one of the plurality of electromagnetic actuators, and
a flex cable connected to the arrangement of coils.

Preferably, the piston assembly is positioned at least partially within the actuator housing and includes:
the piston shaft of the at least one of the plurality of electromagnetic actuators, and
a flexible printed coil having a plurality of printed coil portions wherein ones of the printed coil portions are positioned between the first plurality of magnets and the second plurality of magnets during operation of the at least one of the plurality of electromagnetic actuators.

Preferably, the flexible printed coil includes a multi-layer printed coil comprised of a stacked plurality of flexible insulating layers. Each of the flexible insulating layers includes a printed coil on a first surface thereof. The printed coils on the stacked plurality of insulating layers are electrically interconnected via through holes extending between the first surface and an opposing second surface of each of the plurality of insulating layers. The multi-layer printed coil includes a first coil termination connected to an upper one of the printed coils and second coil termination connected to a lower one of the printed coils.

Preferably, the stacked actuator further includes a flex cable having first and second leads respectively connected to the first coil termination and the second coil termination.

Preferably, at least one of the plurality of electromagnetic actuators includes:

a base housing comprising at least one recess configured to restrain at least one magnet in three dimensions and a channel configured to receive a linear guide;

a top housing fixedly attached to the base housing, wherein the top housing comprises at least one recess configured to restrain another at least one magnet in three dimensions; and

a piston assembly comprising at least a multi-layer printed coil integrated with a flex cable, the piston shaft of the at least one of the plurality of electromagnetic actuators, and a linear encoder scale wherein the piston assembly is positioned between the base housing and the top housing.

In another aspect the disclosure relates to a stacked actuator system including a base platform element and a plurality of electromagnetic actuators mounted on the base platform element. Each of the plurality of electromagnetic actuators includes a piston shaft configured to move between extended and retracted positions. The stacked actuator system further includes a plurality of electrical connectors. A plurality of signal lines are connected between the plurality of electromagnetic actuators and the plurality of electrical connectors. A system housing is mounted on the base platform element and defines an interior volume containing the plurality of electromagnetic actuators. The system housing includes a plurality of apertures through which extends the piston shaft of each of the plurality of electromagnetic actuators.

Preferably, the stacked actuator system further includes a controller mounted on the base platform element and disposed within the interior volume. The controller will also generally be connected to the plurality of electrical connectors.

Preferably, the stacked actuator system further includes a base platform element upon which are mounted the plurality of electromagnetic actuators and the system housing. The plurality of connectors may be disposed on the base platform element between the plurality of electromagnetic actuators and a controller.

Exemplary embodiments of the disclosed linear actuator capable of being used within the stacked actuator system may include a housing having a first planar plate, a second planar plate and a plurality of side members. The plurality of end members may be attached to the first plate and the second plate using a first plurality of screws. The linear actuator includes a first plurality of magnets secured to the first planar plate using a second plurality of screws. A second plurality of magnets are secured to the second planar plate using a third plurality of screws. A piston assembly is positioned at least partially within the housing. The piston assembly includes a shaft and a flexible printed coil having a plurality of printed coil portions. At least certain of the printed coil portions are positioned between the first plurality of magnets and the second plurality of magnets during operation of the linear actuator.

Exemplary embodiments of the disclosed multilayer printed coil arrangement for a linear actuator are shown in the drawings are summarized below. These and other embodiments are more fully described in the Detailed Description section. It is to be understood, however, that there is no intention to limit the disclosure to the forms described in this Summary or in the Detailed Description. One skilled in the art can recognize that there are numerous modifications, equivalents and alternative constructions that fall within the spirit and scope of the methods and apparatus defined by the claims.

In one variation, the multilayer printed coil arrangement includes a coil in the form of a stack of coil elements and a flexible connector coupled to leads of the stack. The stack of coil elements may comprise a plurality of interconnected coil layers. Each coil layer may comprise a conductive material printed on a thin, flexible insulator, such as Kapton. In one implementation the plurality of coil layers are stacked in a vertical dimension and adjacent layers are soldered or otherwise bound together. One of the coil layers may include leads which are connected to leads of the flexible connector or “flex cable”. The flexible connector may include a flexible strip integrated with the insulator of one of the coil layers.

In one particular embodiment the conductive material of each coil layer may comprise carbon nanotubes.

In another aspect the multilayer printed coil arrangement may be included as part of a piston assembly for a linear actuator. In addition to the piston assembly, the linear actuator may include a base housing and a top housing. The base housing may define at least one recess configured to restrain at least one magnet in three dimensions and a channel configured to receive a linear guide. The top housing may be fixedly attached to the base housing and the top housing may define at least one recess configured to restrain another at least one magnet in three dimensions. The piston assembly may comprise at least one and up to six or more stacks of printed coil elements connected to a flex cable, a shaft, and a linear encoder scale, wherein the piston assembly may be positioned between the base housing and the top housing. The shaft can be configured to include a flat end defining a hole such that the shaft can be screwed to the piston assembly in a top-down fashion.

In one aspect, a linear actuator comprises a base housing defining a channel and at least one recess configured to restrain at least a first magnet. A linear guide is attached to the base housing and positioned in the channel. A top housing is fixedly attached to the base housing, wherein the top housing defines at least one recess configured to restrain at least a second magnet. The linear actuator further includes a movable assembly including at least a piston and at least one multilayer printed coil arrangement, wherein the movable assembly is attached to the linear guide and positioned between the base housing and the top housing. The multilayer printed coil arrangement may be oriented such that more coil layers of the multilayer printed coil arrangement are in one or more planes parallel to a line of motion of the movable assembly.

In yet another aspect, a linear actuator comprises a base housing and a linear guide attached to the base housing. The linear actuator further includes a top housing fixedly attached to the base housing, wherein the top housing and the base housing are configured to restrain at least a first magnet and a second magnet. The linear actuator also includes a movable assembly attached to the linear guide and positioned between the base housing and the top housing, wherein the moveable assembly includes at least one multilayer printed coil arrangement. The multilayer printed coil arrangement may be oriented such that more coil layers of the multilayer printed coil arrangement are in one or more planes parallel to a line of motion of the movable assembly.

It is to be understood that both the foregoing general description and the following detailed description are exemplary and are merely intended to provide further explanation of the subject matter.

### BRIEF DESCRIPTION OF THE DRAWINGS

Various objects and advantages and a more complete understanding of embodiments of the present invention are apparent and more readily appreciated by reference to the following Detailed Description and to the appended claims when taken in conjunction with the accompanying Drawings wherein:

FIG. 1 illustrates an exploded view of an exemplary linear actuator which may be adapted to include a multilayer printed coil arrangement in accordance with the disclosure;

FIG. 2 depicts a block diagram of control components of an exemplary linear actuator;

FIG. 3 is a flow diagram illustrating an exemplary process for manufacturing an exemplary linear actuator;

FIGS. 4A-4F provide schematic illustrations of various stages in a method of manufacturing an exemplary linear actuator;

FIGS. 5A-5C depict various view of a linear actuator structured similarly to the linear actuator of FIG. 1;

FIGS. 6A and 6B respectively depict top and perspective view of a multilayer printed coil arrangement in accordance with the disclosure;

FIG. 7 depicts a cross-sectional view of a multilayer printed coil arrangement in accordance with the disclosure;

FIG. 8 depicts a top view of a printed coil arrangement including a set of three multilayer printed coils;

FIGS. 9 and 10 are partially transparent perspective views of a modular linear actuator capable of being inexpensively implemented using a magnet housing lacking milled surfaces;

FIGS. 11A, 11B and 11C respectively provide external views of top, side and end views of the linear actuator of FIGS. 9 and 10;

FIGS. 12A and 12B illustrate a printed coil that can be used in a linear actuator in lieu of coil bobbins;

FIG. 13 is an external perspective view of a first embodiment of a stacked actuator system in accordance with the disclosure;

FIG. 14 is a perspective view of the embodiment of the actuator system of FIG. 13 with the external housing cover removed;

FIG. 15 is an elevated front perspective view of the embodiment of the actuator system of FIG. 13 with the external housing cover removed;

FIG. 16 is an elevated side perspective view of the embodiment of the actuator system of FIG. 13 with the external housing cover removed;

FIGS. 17A-17D depict a second embodiment of a stacked actuator system in accordance with the disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### Stacked Actuator System

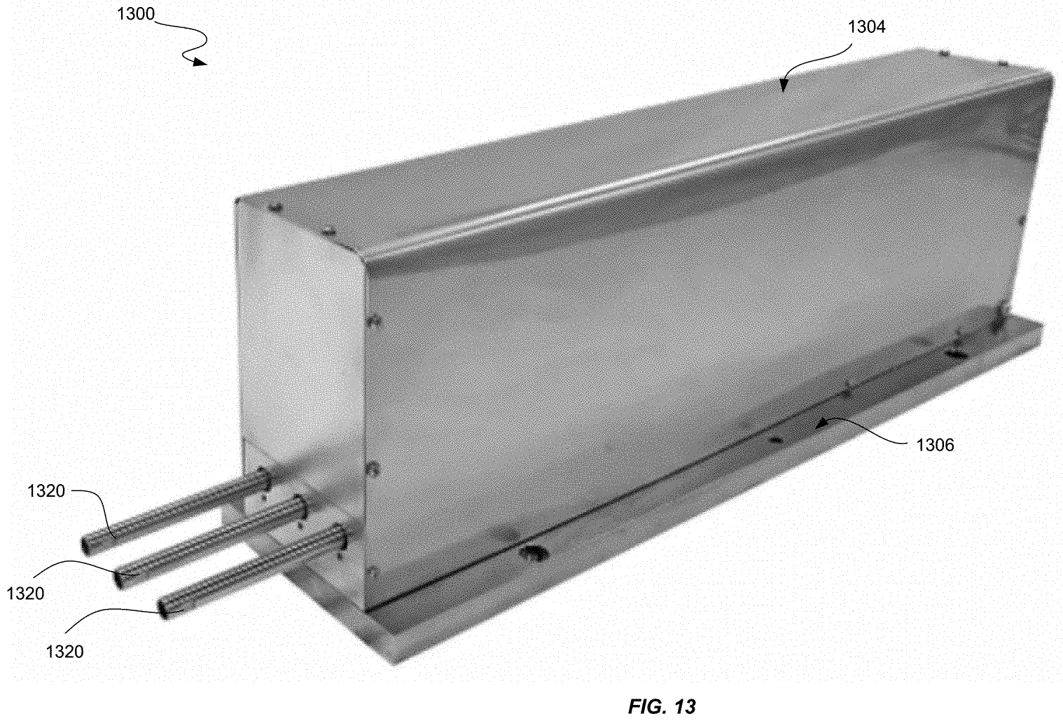

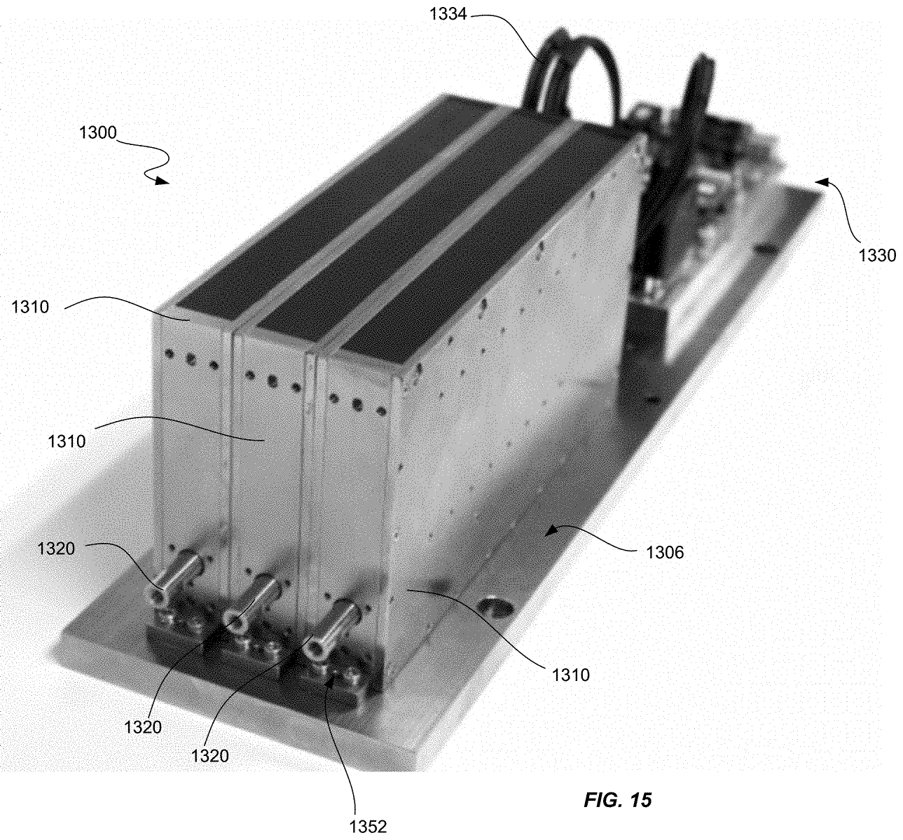

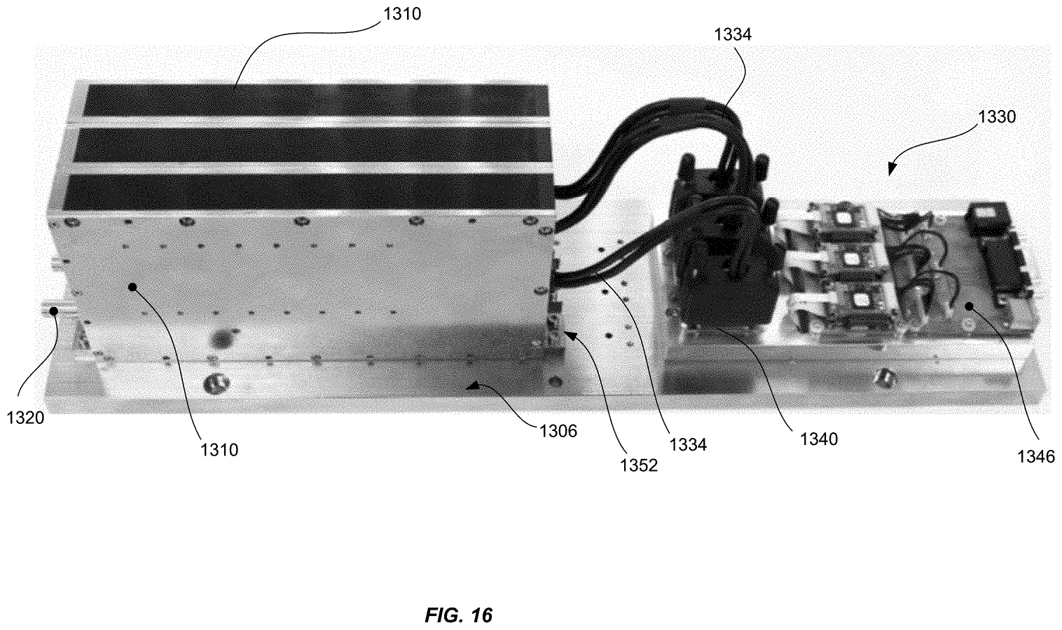

Attention is now directed to FIGS. 13-17, which illustrate embodiments of a stacked actuator system in accordance with the disclosure. As is discussed below, the disclosed stack actuator system combines multiple actuator units into a single assembly, which may also include various control modules. This arrangement simplifies the installation of, and reduces the cabling requirements associated with, the deployment of multiple actuators within various environments. Furthermore, the stacked actuator system allows for the easy, quick exchange of individual actuator units, which reduces down time.

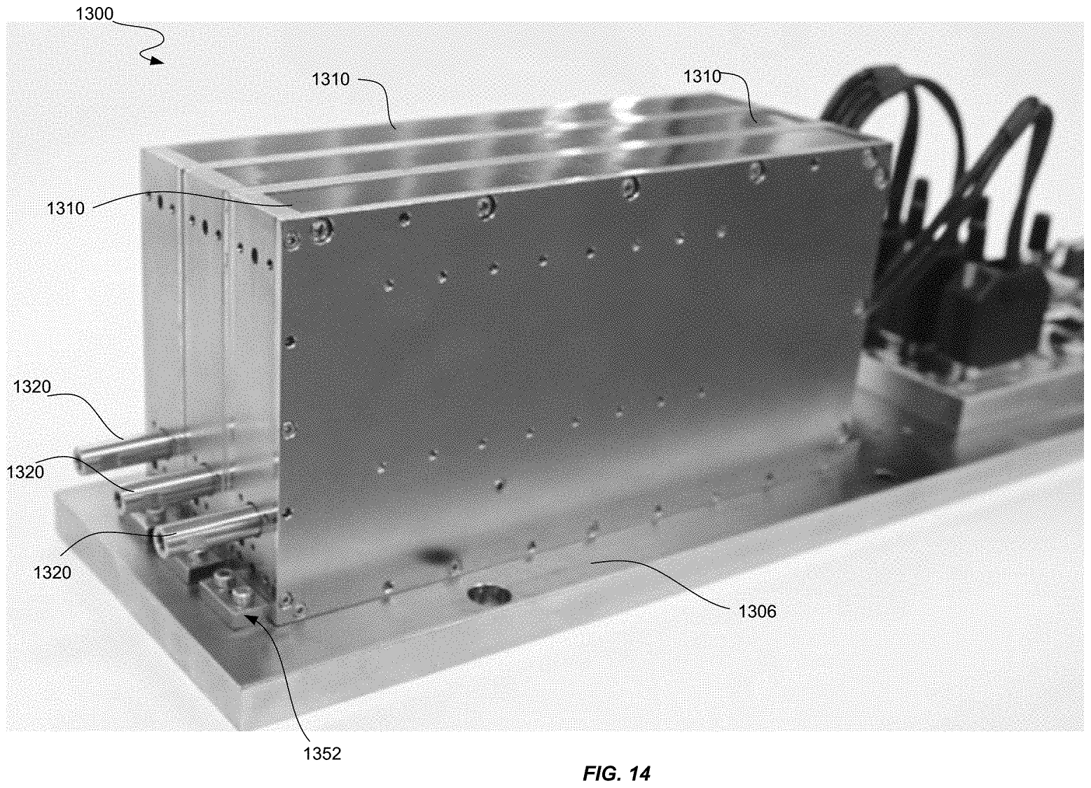

FIGS. 13-16 depict a first embodiment of a stacked actuator system 1300 in accordance with the disclosure. FIG. 13 is a perspective view of the stacked actuator system 1300. The actuator system 1300 includes an external housing cover 1304 defining an interior region and a base platform 1306. FIG. 14 is a perspective of the actuator system 1300 with the external housing cover 1304 removed. As shown, the stacked actuator system 1300 includes a set of three electromagnetic actuator units 1310 disposed within the interior region defined by the external housing 1304. Each actuator unit 1310 includes a shaft 1320 attached to a piston (not shown) internal to the actuator unit. The housing cover 1304 includes a plurality of apertures through which extend the shaft 1320 of each of the electromagnetic actuator units 1310. The piston of each actuator unit 1310 is disposed to move the shaft 1320 of the actuator unit 1310 between extended and retracted positions within a plane substantially parallel to the planar surface of the base platform 1306. Each shaft 1320 may include a vacuum shaft in communication with an interior of a vacuum shaft of its respective actuator unit 1310. This may be effected using a thru shaft vacuum fitting defining an aperture in communication with both vacuum shafts.

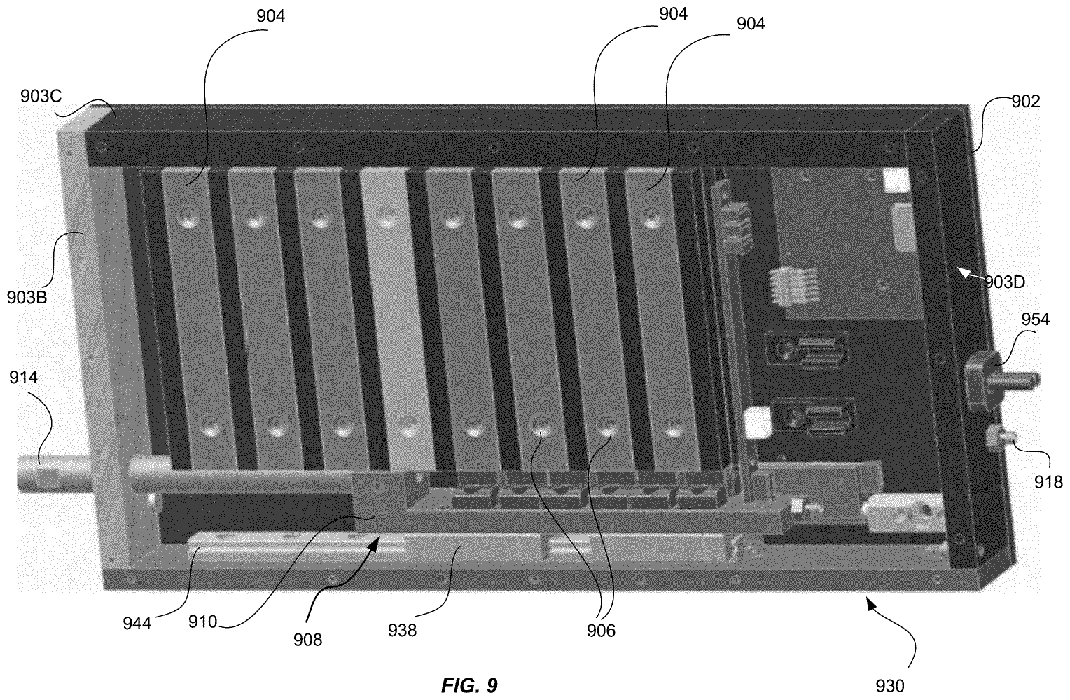

In one embodiment each of the electromagnetic actuator units 1310 may be implemented using, for example, a modular linear actuator of the type described below with reference to FIGS. 9-11. However, in other embodiments different actuator designs may be used to implement the actuator units 1310.

The electromagnetic actuator units 1310 are in communication with a controller unit 1330 over a plurality of signal lines 1334. Each signal line 1334 is connected between one of the three actuator units 1310 and one of three receptacles 1340, which may be disposed on the base platform 1306 between the actuator units 1310 and the controller unit 1330. In one embodiment each of the receptacles 1340 may comprise, for example, a DB26 connector, and has a wired connection to one of a set of electrical connectors on a circuit board 1346 of the controller unit 1330. This permits the controller unit 1330 to provide commands or control signals to the three actuator units 1310 and to receive data and/or status information sent by the actuator units 1310.

The base platform 1306 may include a set of slots or other surface features upon which are mounted the electromagnetic actuator units 1310 and the external housing cover 1304. The electromagnetic actuator units 1310 may each have one or more flange fittings 1352 to assist in securing them to the base platform 1306.

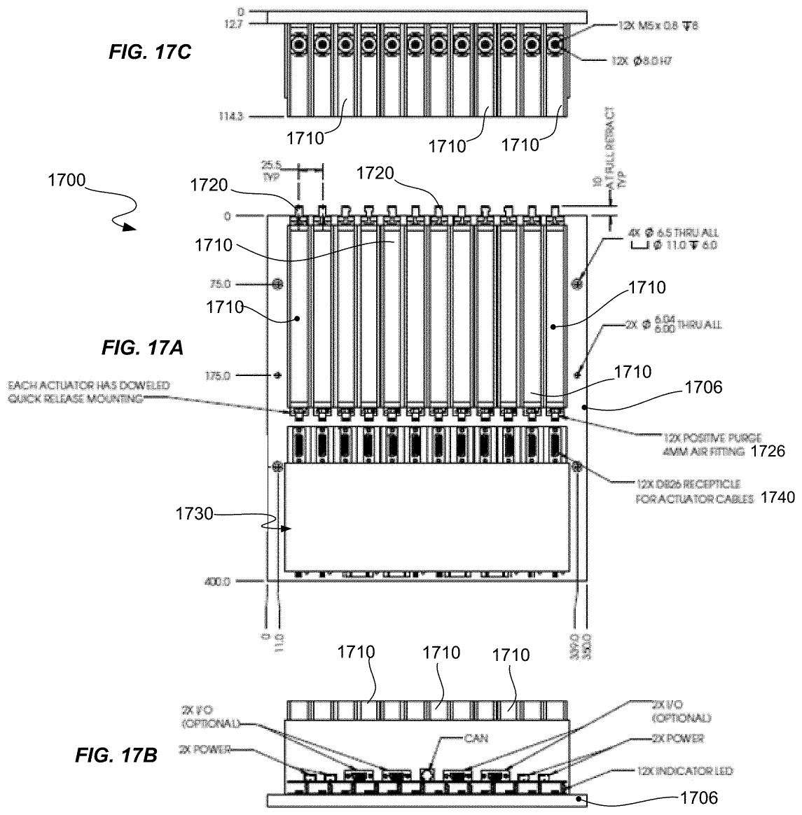

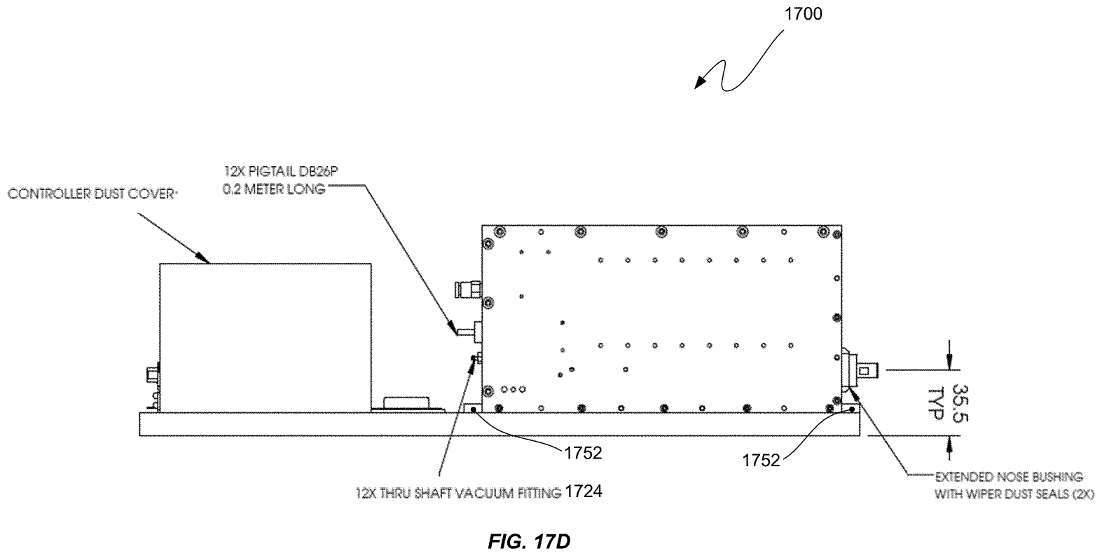

FIGS. 17A-17D depict a second embodiment of a stacked actuator system 1700 in accordance with the disclosure. The embodiment of the stacked actuator system 1700 is substantially similar to the embodiment of the stacked actuator system 1300 (FIGS. 13-16), but includes a set of 12 electromagnetic actuator units 1710 rather than the three electromagnetic actuator units include within the stacked actuator system 1300. Referring now to the drawings, FIG. 17A is a top interior schematic view of a stacked actuator system 1700 having the set of 12 electromagnetic actuator units 1710. Although the actuator system 1700 may include an external housing, such an external housing is not illustrated in FIG. 17A in order to provide the top interior view depicted. FIGS. 17B and 17C are front and rear end views, respectively, of the stacked actuator system 1700. Finally, FIG. 17D is a side view of the stacked actuator system 1700.

As shown, the stacked actuator system 1700 includes a set of twelve electromagnetic actuator units 1710 mounted on a base platform 1706. Each actuator unit 1710 includes a shaft 1720 attached to a piston (not shown) internal to the actuator unit 1710. In embodiments with a housing cover (not shown), the housing cover includes a plurality of apertures through which extend the shaft 1720 of each of the electromagnetic actuator units 1710. The piston of each actuator unit 1710 is disposed to move the shaft 1720 of the actuator unit 1710 between extended and retracted positions within a plane substantially parallel to the planar surface of the base platform 1706. Each shaft 1720 may include a vacuum shaft in communication with an interior of a vacuum shaft of its respective actuator unit 1710. This may be effected using a thru shaft vacuum fitting defining an aperture in communication with both vacuum shafts. Each actuator unit 1710 includes a thru shaft vacuum fitting 1724 and a positive purge air fitting 1726.

In one embodiment each of the electromagnetic actuator units 1710 may be implemented using, for example, a modular linear actuator of the type described below with reference to FIGS. 9-11. However, in other embodiments different actuator designs may be used to implement the actuator units 1710.

The electromagnetic actuator units 1710 are in communication with a controller unit 1730 over a plurality of signal lines (not shown). Each signal line is connected between one of the twelve actuator units 1710 and one of twelve receptacles 1740, which may be disposed on the base platform 1706 between the actuator units 1710 and the controller unit 1730. In one embodiment each of the receptacles 1740 may comprise, for example, a DB26 connector, and has a wired connection to one of a set of electrical connectors on a circuit board of the controller unit 1730. This permits the controller unit 1730 to provide commands or control signals to the actuator units 1710 and to receive data and/or status information sent by the actuator units 1710.

The base platform 1706 may include a set of slots or other surface features upon which are mounted the electromagnetic actuator units 1710 and, optionally, an external housing cover. The electromagnetic actuator units 1710 may each have one or more flange fittings 1752 to assist in securing them to the base platform 1706.

### Multi-Layer Printed Coils for Linear Electromagnetic Actuators

Reference will now be made in detail to embodiments of a modular linear actuator assembly capable of being used within the stacked actuator system described herein. In addition, a description is provided of multilayer printed coil arrangements that may be used for linear electromagnetic actuators. A modular actuator design which substantially obviates the need for the use of milled housing parts is also described. A description of the multilayer printed coil arrangements applicable to a variety of actuator designs is followed by a description of the modular linear actuator design. This modular design utilizes a housing comprised of mounting plates rather than milled housing elements and may be utilized in combination with the disclosed printed coil arrangements in the stacked actuator system of the disclosure.

The multilayer printed coil arrangements disclosed herein may be used in moving coil electromagnetic actuators and are of lower mass than conventional coil structures using bobbins. Such lower mass enables electromagnetic actuators to be realized with piston structures capable of relatively greater acceleration. Moreover, the precision with which the multilayer printed coils described herein may be manufactured enables actuator designs with reduced tolerances and correspondingly closer placement of such coils to actuator magnets, thus facilitating relatively greater force production.

In one embodiment each layer of the disclosed multilayer coils is produced by printing or otherwise depositing carbon nanotubes in a coil pattern.

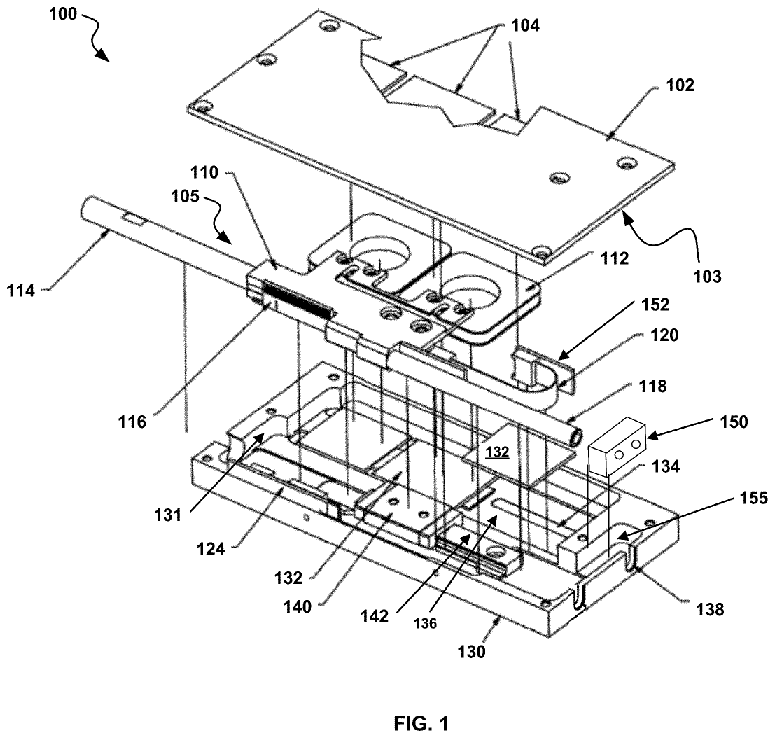

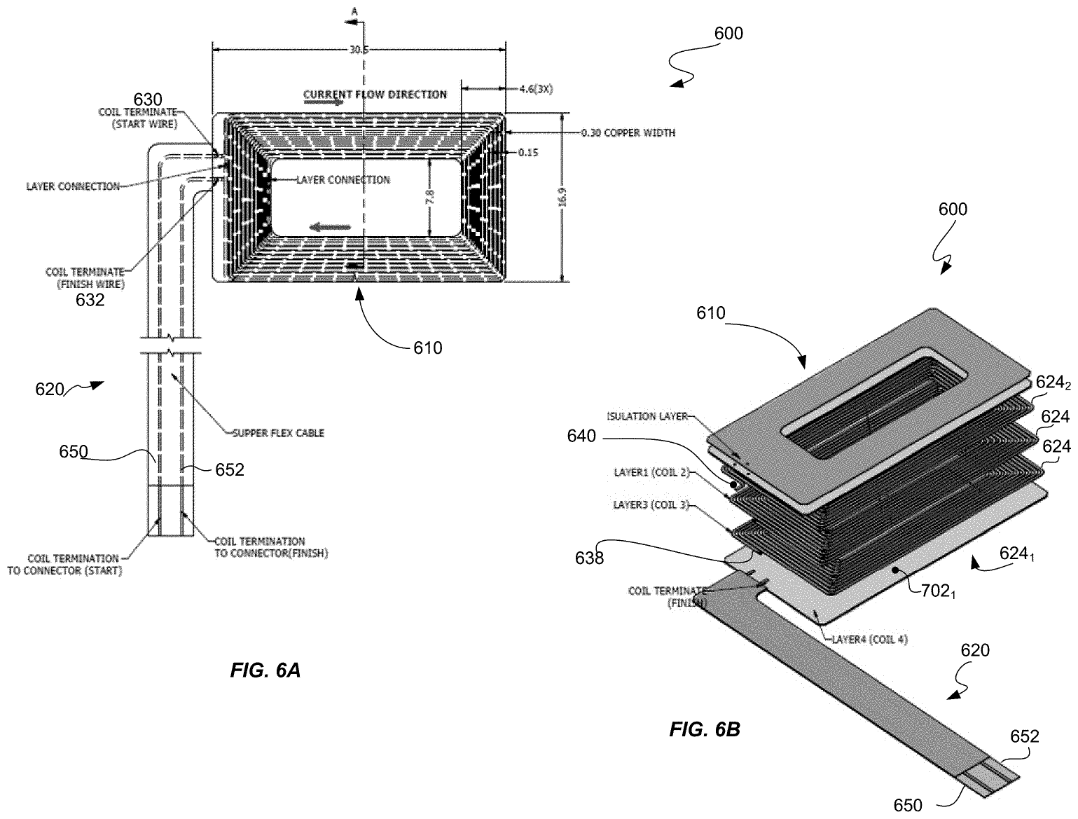

Although the disclosed multilayer printed coil arrangement could be used within a variety of actuator designs, FIGS. 1-5 illustrate a particular linear actuator design which could be readily adapted to accommodate the multilayer printed coil arrangement in the manner described hereinafter. FIGS. 6-8 illustrate particular embodiments of multilayer printed coil arrangements in accordance with the disclosure.

FIG. 1 illustrates an exploded view of a linear actuator 100. Linear actuator 100 may include a top magnet housing 102 and a base housing 130. Top magnet housing 102 may define recesses (not shown) on an inside surface 103 for receiving at least one magnet 104. In FIG. 1, top magnet housing 102 is partially cut away to reveal the at least one magnet 104. The recesses may be contoured within the surface 103 to allow the at least one magnet 104 to “snap” into place, that is, to physically restrain the at least one magnet 104 in three dimensions once the linear actuator 100 has been assembled. Thus, the at least one magnet 104 may be easily assembled in top housing 102 without a need for location tooling. The top magnet housing 102 may also include grooves for receiving epoxy to bond the magnets 104 in position.

Top magnet housing 102 may be manufactured as a steel casting using a mold. Simple machine finishing of about 0.1 mm may be added to create the finished component.

Base housing 130 can be a steel casting formed with a mold. The mold used to make the base housing 130 can be configured to be adjustable for providing variable length base housings with longer or shorter strokes. In one embodiment, the same mold can be used to fabricate housings with five or more different length strokes. Base housing 130 may also define recesses (not shown) on an inside surface 136 for receiving at least one magnet 132. The recesses may be contoured to allow the at least one magnet 132 to “snap” into place, that is, to physically restrain the at least one magnet 132 in three dimensions once the linear actuator 100 is assembled. Thus, the at least one magnet 132 may be easily assembled in base housing 130 without a need for location tooling. The base magnet housing 130 may also include grooves 134 for receiving epoxy to bond the magnets in position. The base housing 130 is configured such that the magnets 132, the glue, a linear guide 140 slidably mounted on a rail 142, and a cable assembly 150 can be assembled via vertical placement from the top down. The base housing 130 may also include an aperture 138 for receiving an interface cable, such as a cable for a suction pump.

As an alternative to recesses configured such that the magnets 104 and 132 can snap into place, the recesses can be configured to be larger than the magnets 104 and 132 and/or a different shape than the magnets 104 and 132. In this alternative configuration, the magnets 104 and 132 can be glued into place with the glue being deposited in the recesses themselves which can be about 100 microns deep. For example, the recesses could be circular and dimensioned such that the square magnets 104 and 132 fit into the circular recesses. Circular recesses are more easily machined than square or rectangular recesses.

The top housing 102, the base housing 130 and the magnets 104 and 132 combine to form what is referred to as a magnetic circuit. The top housing 102 and the base housing 130, referred to collectively as a magnetic circuit steel, serve as return lines to interconnect the magnets 104 and 132 of the magnetic circuit and to help contour the magnetic field. Previous actuator designs have utilized a separate interior housing to support magnets. In addition, previous actuator designs have utilized separate end plates and/or side plates. In contrast, the linear actuator 100 uses only the top housing 102 and the base housing 130 to mount the magnets where the base housing 130 defines the sides and ends of the linear actuator 100. This one housing design can be used due to, at least in part, the light weight of the moving parts and the small size of the magnets 104 and 132 the of the linear actuator 100.

Base housing 130 may combine the magnet circuit steel with a section holding a movable assembly 105 comprised of, for example, a piston 110, one or more coil bobbins 112, two shafts 114 and 118, a flexible cable 120 and a linear encoder scale 116. The configuration of the movable assembly 105 may advantageously reduce the number of parts and reduce manufacturing costs. In one embodiment the coil bobbins 112 may be plastic molded. The coil bobbins 112 and two shafts 114 and 118 are connected to the piston 110 prior to assembly and combined unit comprised of piston 110 and bobbin 112 of the movable assembly 105 is attached to the linear guide 140 using screws. This attachment may proceed in a downward vertical motion perpendicular to the inner surface 136 of the base housing 130. The coil bobbins 112 are flat coils with the coil windings parallel to the travel of the piston 110 on the linear guide 140. Previous electromagnetic actuators have used coils where the windings were at right angles to the direction of travel. By utilizing flat coils, the thickness of the linear actuator 100 may be reduced. For example, in one embodiment the linear actuator 100 with flat coils can be 8 mm thick or even less, thereby being small enough to be used for placing electronic parts where pitch between electronic parts can be 8 mm. The piston 110 can also be configured to mount three coil bobbins 112. By providing options for 2 coil or 3 coil versions, the linear actuator 100 can be controlled using either a single-pole or multi-pole controller as described below.

The movable assembly 105 can be assembled in a top-down fashion. In one embodiment, the coil bobbins 112 are wound from the top-down during the assembly of the movable assembly. In this embodiment, a bottom plate includes two posts on which the coil bobbins 112 are wound from the top. A top plate is then coupled to both posts securing the coil bobbins together in the movable assembly 105.

Base housing 130 may also define a machined channel for receiving the rail 142 on which the linear guide 140 is slidably mounted. The channel may include a datum location and the rail 142 may positioned in relation to this datum location. In one embodiment linear guide 140 comprises a commercially available linear guide such as, for example, the LWL manufactured by IKO®, having an expected lifetime in a range of 100M cycles. Thus, linear actuator 100 may be expected to have a useful lifetime substantially longer than the lifetime of conventional pneumatic slides.

Base housing 130 includes a location for a linear encoder reader head 124. The linear encoder reader head 124 may be positioned in reference to the datum location. The linear encoder reader head 124 is assembled such that it is located at a precise distance from the datum location. In this way, when the movable assembly 105 is also assembled in relation to the datum location, the linear encoder reader head 124 is positioned at a precise distance (e.g., 0.5 mm within a combined tolerance of +/−0.1 mm) from the linear encoder scale 116 that is on the movable assembly 105. The linear encoder reader head 124 is configured to read the linear encoder scale 116 positioned on the movable assembly 105.

Some or all of the features of base housing 130 such as, for example, recesses, grooves, apertures, channels, and a location for a linear encode reader head, may by machined at the same time. In one embodiment, horizontal milling is used to machine these features. The base housing 130 can be screwed to a surface of the milling machine as a means for clamping the base housing 130 during assembly. This simple method of restraint can improve tolerance control since the base housing is not indexed during machining of these critical features. The mold which may be used to form the base housing 130 can be configured such that the various recesses and glue grooves (if present) are formed by the casting process. In this way, less machining is required to ensure very tight tolerances for the locations and dimensions of the recesses, grooves and screw holes. For example, in one embodiment the dimensions of the base housing 130 can be machined to within +/−10-20 microns. In addition, the casting mold can be dimensioned such that the recesses and grooves can be formed to these very tight tolerances by removing about 200-300 microns of material or less. The use of a casting with tight tolerances advantageously allows the various interior parts of the linear actuator 100 to be placed using simple drop and place techniques, thereby reducing the time and cost of manufacture.

The piston 110 may be injection molded from machinable plastic or be made out of aluminum, either by using a casting mold or being extruded. The front edge and bottom edge of the piston 110 are machined precisely since these two surfaces control the position of the piston 110 relative to the datum location when the piston 110 is mounted on the linear guide 140 and the rail 142 is mounted in relation to the datum location. The edge of the base housing 130 on which the reader head 124 is mounted is also machined precisely such that the combined tolerances of the two machined surfaces of the piston 110 and the edge of the base housing 130 are separated by a gap of about 0.5 mm+/−0.1 mm. The piston 110 may be configured to provide mounting positions to accommodate one, two, three or more coil bobbins 112 The piston 110 may be made out of injection molded plastic. The piston 110 may also include screw holes in order to facilitate its mounting on the linear guide 140 using screws. The plastic of the piston 110 may be machined to conform to the top surface of the linear guide 140. In contrast to plastic, aluminum pistons often increase the friction experienced by linear guides by bending or otherwise deforming the walls of such guides, thereby potentially reducing expected life. Thus, the use of a plastic-molded piston 110 may further prolong useful lifetime of embodiments of the linear actuator 110. As shown in FIG. 1, the piston 110 includes a bore for the shaft 114 and defines an area for the linear encoder scale 116.

Employing at least one coil bobbin 112 in lieu of the free standing coils typically used in small disc drive type electromagnetic actuators may advantageously reduce manufacturing time and avoid the need to glue coils into place. Coils may advantageously be automatically wound around the bobbins 112.

Again referring to FIG. 1, shaft 114 is attached to piston 110. In the embodiment of FIG. 1 the shaft 114 illustrated as a vacuum shaft, but in other variations the shaft 114 is solid. When shaft 114 comprises a vacuum shaft, a hole may be cut through the center of the shaft for vacuum pick up. Thru shaft vacuum 118 may facilitate vacuum pick up. A compression spring (not shown) may be mounted between the piston 110 and a front wall 131 of the base housing 130 to return the piston to a retracted position once power is cut or to counter balance a weight if the unit is mounted vertically, for example.

Piston 110 may also have a flex cable 120 for controlling various functions of the linear actuator 100. For example, the flex cable 120 may be used to provide power to the coils of the coil bobbins 112 or to facilitate communication between cable assembly 150 and the coil so that, for example, an external controller can control the rate and positioning of the shaft. The cable assembly 150 includes a connector board configured to couple to external cable that includes about 16 lines in the cable. The cable assembly 150 is mounted in a cavity 155 to be communicatively coupled to the flex cable 120 via an electrical connector 152. The cable assembly 150 can be mounted on the base housing 130 on two posts that are machined to precise heights so as to be aligned precisely. The cable assembly 150 is also able to be attached to the base housing 130 using a downward vertical motion perpendicular to the inner surface 136 of the base housing 130.

The various components of linear actuator 100 may include apertures and corresponding recesses for fixedly coupling different parts by use of screws, for example.

Because of the simple design of the individual parts of linear actuator 100, total manufacturing time for parts used in this device may be less than 15 minutes. Total assembly time, when performed manually, may be less than 5 minutes. Assembly of the linear actuator, since performed vertically down, lends itself easily to automation. Manufacturing cost may then be further reduced by 75%, as compared to a manual assembly.

These manufacturing and assembly times may cut production time by more than 75% compared to conventional linear servo motor electromagnetic actuators. As a result, the cost of manufacturing linear actuator 100 may be less than or equal to twice that of pneumatic slides.

In addition, the simple design may mean that this actuator can be a viable replacement for pneumatic slides because the expected ten times greater cycle life more than offsets the cost to the customer of less than or equal to twice that of a pneumatic actuator.

Pneumatic slides currently represent about 20% of the total yearly sales of pneumatic electromagnetic actuators. The low-cost, long-life development described advantageously enables customers to improve the quality of their machines both in terms of work done and mean time between failures.

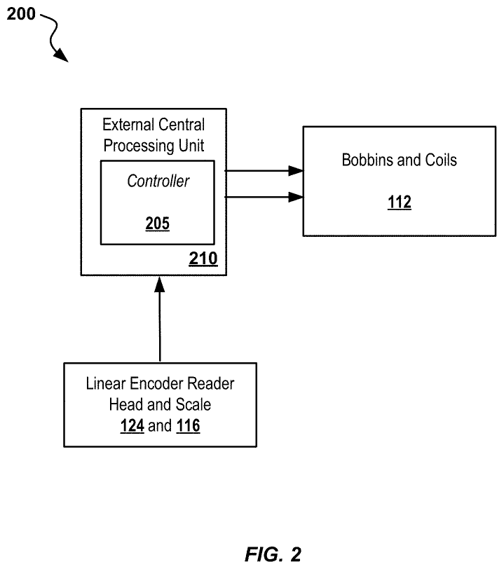

FIG. 2 depicts a block diagram of control components of the linear actuator 100. The control components include an external central processing unit 210, the coil bobbins 112 and linear encoder components including the linear encoder reader head 124 and the linear encoder scale 116. The external central processing unit 210 executes computer readable instructions embodying a controller 205.

During operation of the linear actuator 100, the controller 205 and the external central processing unit 210 operate to control an electric current provided to the coil bobbins 112. An electromotive force is supplied to the piston 110 by the interaction between the magnets 132 and 104 and an electromagnetic field generated in response to the provision of this electric current to the coil bobbins 112. This electromotive force can provide linear reciprocal movement to the entire movable assembly 105 including the piston 110, the bobbin coils 132, the shafts 114 and 118, the flexible cable 120 and the linear guide 140. The linear encoder read head 124, which attached to the base housing 130, and the linear encoder scale 116, which is attached to the piston 110, interact to provide a feedback signal to the external central processing unit 210 and the controller 205. The feedback signal tracks the linear motion of the movable assembly 105 and, hence, the shafts 114 and 118. Thus the controller 205 is able to selectively position the piston 110 along the entire path provided by the linear guide 140.

The controller 205 can be configured to use a single-pole control system (a linear version of a brush motor) for a linear actuator having two bobbin coils. The control system for the two coil version has only a single magnet circuit and therefore the electromotive force decreases over a longer stroke. The controller 205 can also be configured with a multiple-pole control system (a linear version of a brushless motor) for a linear actuator having three bobbin coils. For this multiple-pole control system, the electromotive forces generally stay the same over an entire stroke. For example, a single pole circuit could be utilized for strokes in a range of 10 mm to 15 mm and multi-pole circuits could be utilized for strokes greater than 15 mm.

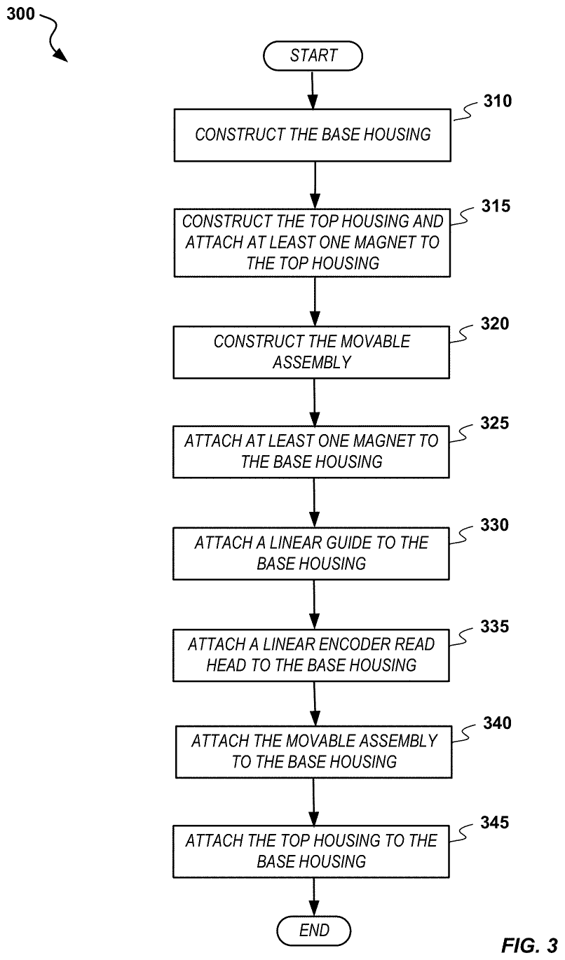

FIG. 3 shows and example of a flow diagram illustrating an exemplary process 300 for manufacturing a linear actuator in accordance with the disclosure. The process 300 can be used to manufacture the linear actuator 100 of FIG. 1. The process 300 starts at stage 310 with the base housing being constructed. The base housing can be constructed using a steel casting mold. The steel casting mold can be configured such that recesses, grooves and channels for attaching the other internal components are constructed, at least partially, during the casting process. The recesses, grooves and channels may require further machining, depending on the configuration and/or the desired tolerances. The base housing is configured such that the attachment of the internal components can accomplished using a linear motion in one direction, such as vertically as described above.

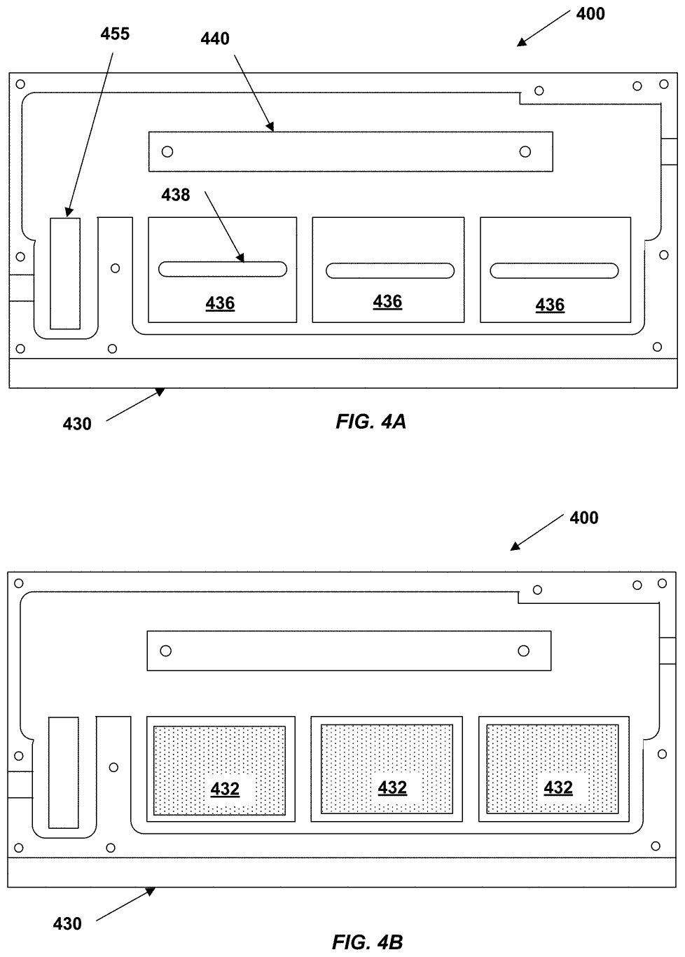

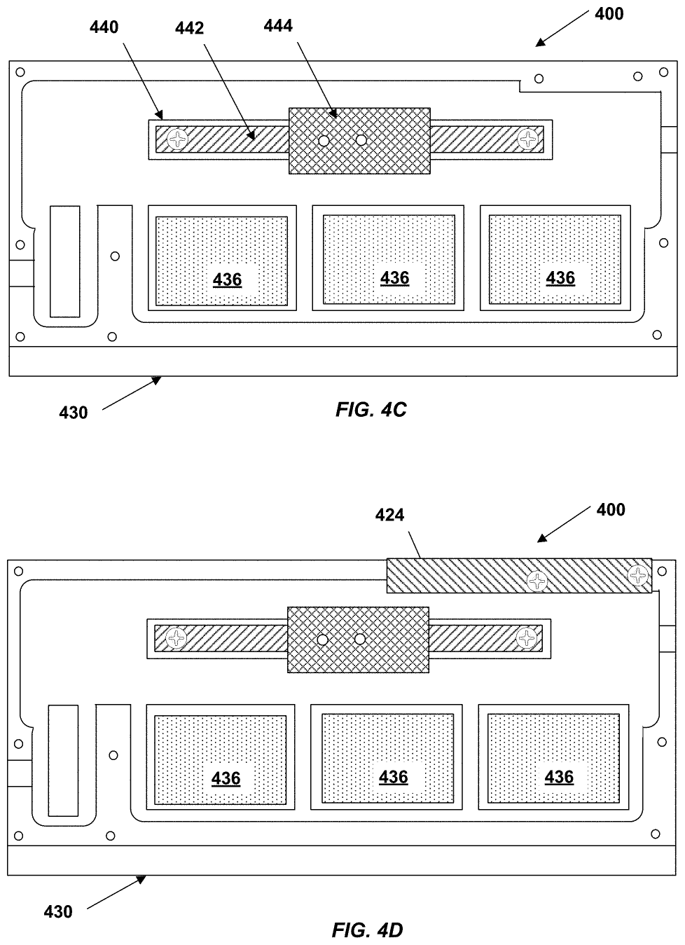

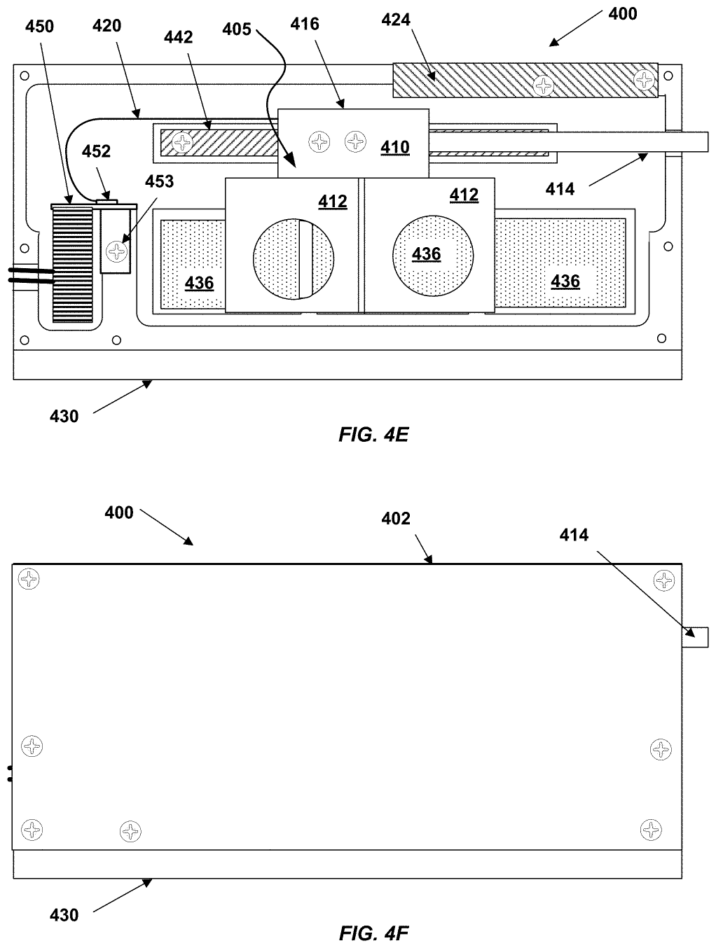

FIG. 4A illustrates a base housing 430 constructed at stage 310 during construction of a linear actuator 400. The base housing 430 defines three recesses 436 for receiving three magnets. Each recess 436 is formed to include a glue groove 438 such that glue, e.g., epoxy, can be applied prior to the magnets being attached. The base housing 430 also defines a channel 440 for receiving a linear guide rail and a channel 455 for receiving a cable assembly. Rectangular recesses 436 are illustrated in FIG. 4A, but the recesses 436 could be other shapes including, for example, square, circular, etc.

Returning to FIG. 3, the process 300 continues to stage 315 with the construction of the top housing. The top housing is also constructed using a steel casting mold. The top housing is cast to define three recesses to receive three other magnets which are also attached to the top housing at stage 315.

At stage 320, the movable assembly is constructed. The movable assembly is constructed to include a piston, at least one bobbin coil, at least one shaft, a flexible cable and a linear encoder scale. In one embodiment, the movable assembly constructed at stage 320 is the movable assembly 105 described above.

At stage 325 and in further reference to FIG. 4B, three magnets 432 are attached to the base housing 430 so as to be constrained in the recesses 436 in three dimensions. Depending on the configuration of the recesses 436, the magnets 432 can be snapped into place or glued. The magnets 432 and the glue, if needed, can be placed into the recesses 436 and the grooves 438 manually or using automated means for picking and placing parts. The design of the base housing 430 allows the placement of the magnets, and all other internal components, in a single direction perpendicular to a floor of the base housing 430.

At stage 330, and in further reference to FIG. 4C, a linear guide 444 slidably coupled to a rail 442 is attached to the base housing 430 with two screws in the channel 440. The linear guide 444 and rail 442 could also be glued into the channel 440 in other embodiments.

At stage 335, and in further reference to FIG. 4D, a linear encoder read head 424 is attached to a wall of the base housing 430 using two screws. The linear encoder read head 424 could also be attached using glue or other adhesives.

At stage 340, and in further reference to FIG. 4E, a movable assembly 405 (constructed at stage 320) is attached to the linear guide 444 with two screws. The movable assembly includes a piston 410, two bobbin coils 412, a shaft 414, a linear scale 416 and a flexible cable 420. The linear scale 416 is located so as to be readable by the linear encoder read head 424 as the piston 410 moves along the rail 442. FIG. 4E also shows a cable assembly 450 attached to the base housing with a screw 453 so as to be electrically connected to an electrical connector 452 of the flexible cable 420. The cable assembly 450 can be attached at the same time as the movable element 405 at stage 340 or at a different time. The cable assembly 450 is also electrically coupled to two wires that exit the base housing via a cutout to connect to an external central processing unit including a controller as discussed above in reference to FIG. 2.

At stage 345, and in further reference to FIG. 4F, a top housing 402, that was constructed at stage 315, is attached to the base housing using seven screws in this example. The top housing 402 is attached to the base housing 430 such that the magnets attached to the base housing and the top housing are enclosed within the base housing 430 and the top housing 402. In addition, all the other components attached at the stages 325, 330, 335 and 340 are also enclosed between the base housing 430 and the top housing 402.

The linear actuator 400 constructed with the process 300 can be manufactured quickly and inexpensively due to the design of the base and top housings 430 and 402, and due to the layout of the components within the housings. All the components can be attached to the base housing, either manually or using automated means, using a simple linear motion in a single direction that is perpendicular to the floor of the base housing 430. In addition, the linear actuator 400 can be very thin, 8 mm or smaller, thereby being able to be used for manufacturing small components unsuitable for manipulation using larger electromagnetic actuators (electrical, pneumatic or other).

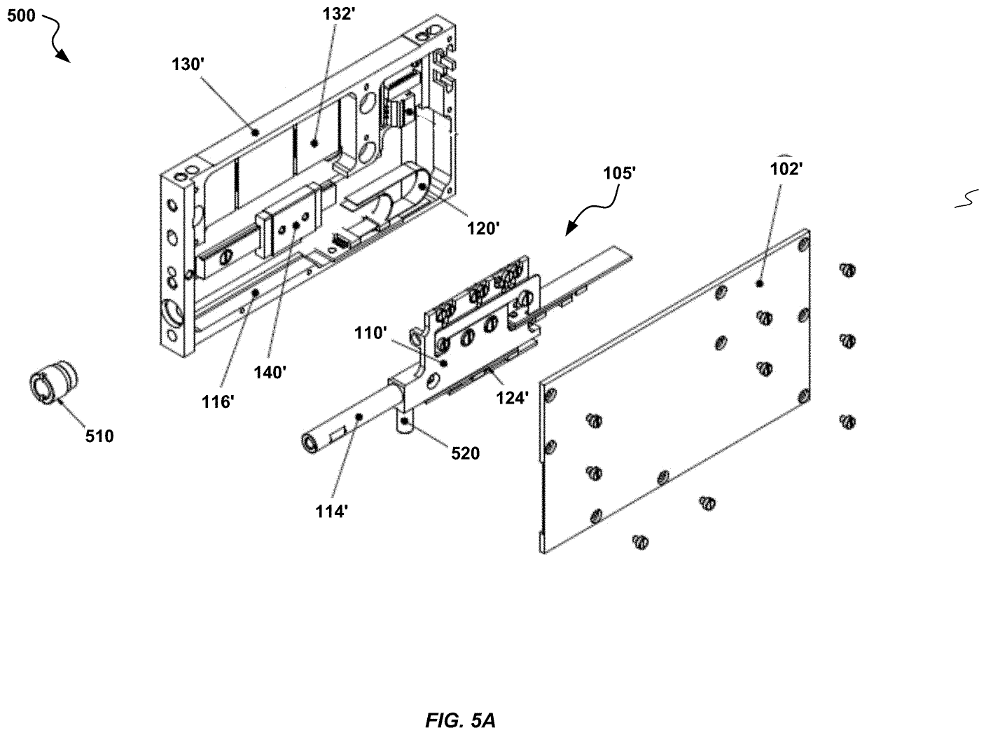

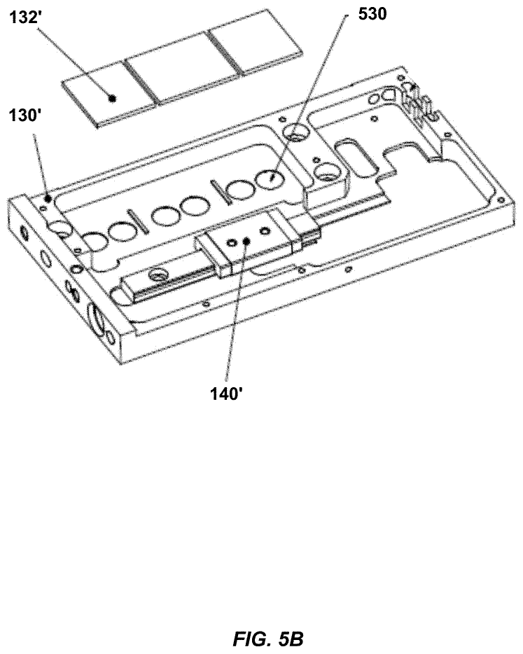

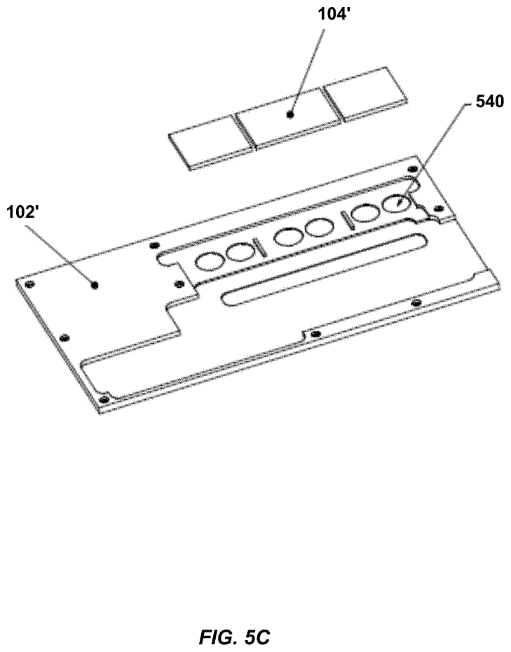

Attention is now directed to FIGS. 5A-5C, which depict a linear actuator 500 structured similarly to linear actuator 100. Accordingly, like reference numerals will be used in FIGS. 5A-5C to refer to corresponding elements of FIG. 1. For example, reference numeral 130′ is used in FIG. 5A to identify the base housing structure corresponding to the base housing 130 of FIG. 1.

Turing to FIG. 5A, an exploded view is provided of the linear actuator 500. In addition to the primed reference numerals used to identify elements corresponding to those described with reference to FIG. 1, the embodiment of FIG. 5A is seen to further include a bushing 510 insertable into the base housing 130′ and a vacuum port 520 defined by the piston 110′.

FIG. 5B depicts a top view of the base housing 130′ for the linear actuator 500. In addition to the elements of the base housing 130′ identified in FIG. 5A, in one embodiment the base housing 130′ further defines a plurality of epoxy pockets 530 for securing permanent magnets 132′.

FIG. 5C illustrates an inner surface of the top magnet housing 102′ of the linear actuator 500. As shown, in one embodiment the top magnet housing 102′ further defines a plurality of epoxy pockets 540 for securing permanent magnets 104′.

FIGS. 6A and 6B respectively depict top and perspective views of a multilayer printed coil arrangement 600 in accordance with the disclosure. In one embodiment the multilayer printed coil arrangement 600 may be used within the linear actuator described above with reference to FIGS. 1-5. For example, the multilayer printed coil arrangement 600 may be used in lieu of, and replace, the one or more coil bobbins 112 and flexible cable 120 of the linear actuator 100.

Referring to FIGS. 6A and 6B, the multilayer printed coil arrangement 600 includes a stack of interconnected coil elements 610 and a flexible connector 620. As shown, the stack of coil elements 610 is comprised of multiple coil layers 624 collectively comprising an actuator coil. A first outer coil layer 624₁ of the multiple coil layers 624 includes a pair of wire leads, i.e., a start lead 630 and a finish lead 632, for conducting current to and from the stack of coil elements 610, respectively. In one embodiment the finish lead 632 is connected to an end 638 of a printed coil of the first outer coil layer 624₁ and the start lead 630 is connected to an end 640 of a printed coil of a second outer coil layer 624₂. The start lead 630 is also connected to a first connection line 650 of the flexible connector 620 and the finish lead 632 is connected to a second connection line 652 of the flexible connector 620.

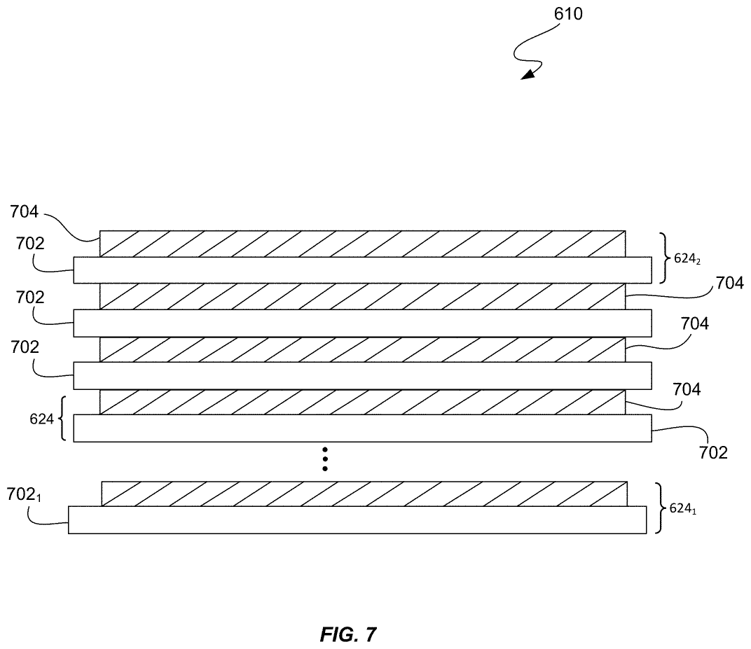

Turning now to FIG. 7, a cross-sectional view is provided of the stack of interconnected coil elements 610. As shown, each coil layer 624 within the stack 610 is comprised of an insulating layer 702, such as Kapton, and a conductive coil element 704. In one embodiment the stack 610 includes five coil layers 624, although in other embodiments the stack 610 may include any number of coil layers 624 in order create actuator coils of any number of turns. In one embodiment each conductive coil element 704 is printed or otherwise deposited upon its insulating layer 702 in order to create each coil layer 624. The coil layers 624 created in this manner may then be stacked and adjacent layers soldered or otherwise coupled together. The conductive coil elements of adjacent coil layers 624 may be interconnected via metallized through holes in each insulating layer 702. Once stacked and interconnected, the plurality of coil layers 624 may then be collectively laminated. In one embodiment the flexible connector 620 is joined to, or may be contiguous with, the insulating layer 7021 of the first outer coil layer 624₁.

In one embodiment conventional deposition techniques may be used to deposit each conductive coil element 704 on a corresponding insulating layer 702. For example, a ProtoMat E33 from LPKF Laser & Electronics AG may be used to effect deposition of a conductive coil element 704 comprised of, for example, copper, on an insulating layer 702. In addition, start and finish coil termination leads may be deposited directly on one or a pair of the insulating layers 702. This advantageously eliminates the need for a separate connection board or structure between a coil and a flex cable containing electrical connection lines for the coil. In an exemplary embodiment each conductive coil element 704 has a thickness of approximately 30 microns and a width of approximately 100 microns. As used herein, the term “printed coil” or “multilayer printed coil” and variants thereof includes coil structures produced using the aforementioned conventional deposition techniques.

Since insulating layers 702 comprised of, for example, Kapton can be manufactured to within relatively stringent width tolerances (e.g., +/−0.5 microns), the dimensions of each stack of interconnected coil elements 610 may be held within a precise range. This enables actuator designs in which coils in the form of stacks of interconnected coil elements 610 may be positioned relatively closer to fixed actuator magnets, thus enabling higher actuator forces to be produced. Moreover, as a result of the precision in the dimensions of each insulating layer and associated conductive coil element 704, each coil layer 624 (i.e., coil turn) may be positioned relatively closer to adjacent turns than is possible in conventional designs.

A variety of materials may be used for the conductive coil element 704 and the corresponding insulating layer 702. For example, in one embodiment the conductive coil element 704 is comprised of carbon nanotubes. Advantageously, carbon nanotubes may generally conduct substantially greater amounts of current for a given level of heat output relative to conventional conductive materials. Aixtron SE manufactures equipment capable of depositing carbon nanotubes on suitable insulating substrates using a plasma enhanced chemical vapor deposition process.

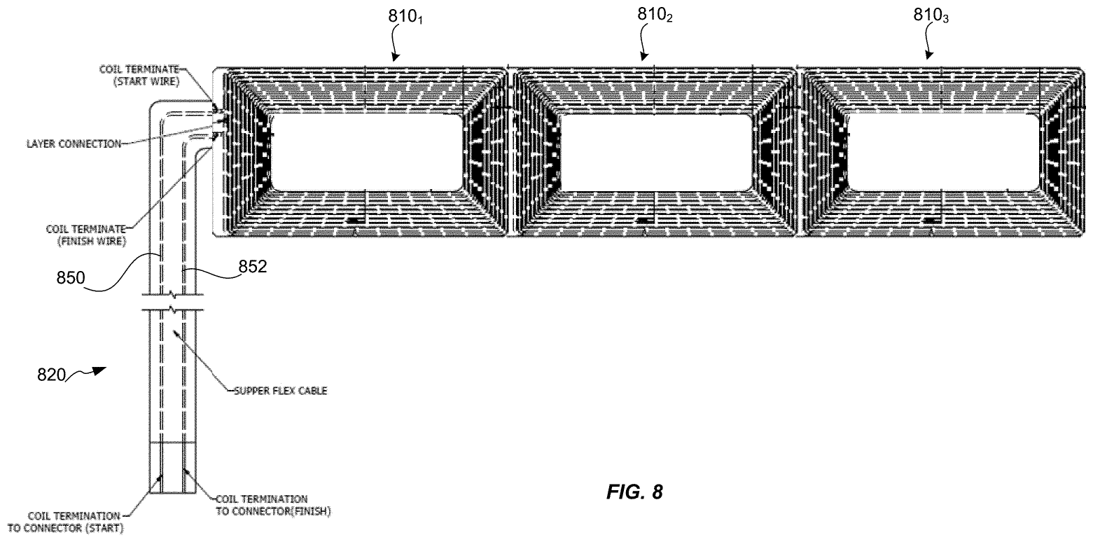

FIG. 8 depicts a top view of a printed coil arrangement 800 including a set of three printed coil structures, each of which is comprised of a stack of interconnected coil elements 810. Each stack of interconnected coil elements 810 may be structured substantially similarly or identically to the stack of interconnected coil elements 610 depicted in FIGS. 6 and 7. As shown, the printed coil arrangement 800 includes a flexible connector 820 that is joined to, or contiguous with, an insulating layer of one of the coil layers of the first stack of interconnected coil elements 8101. In one embodiment a first coil layer within the first stack of interconnected coil elements 8101 includes a pair of wire leads, i.e., a start lead and a finish lead, for conducting current to and from the three stacks of interconnected coil elements 8101, 8102, 8103. The start lead is also connected to a first connection line 850 of the flexible connector 820 and the finish lead is connected to a second connection line 852 of the flexible connector 820.

### Modular Linear Actuator Using Arrangement of Thin or Printed Coils

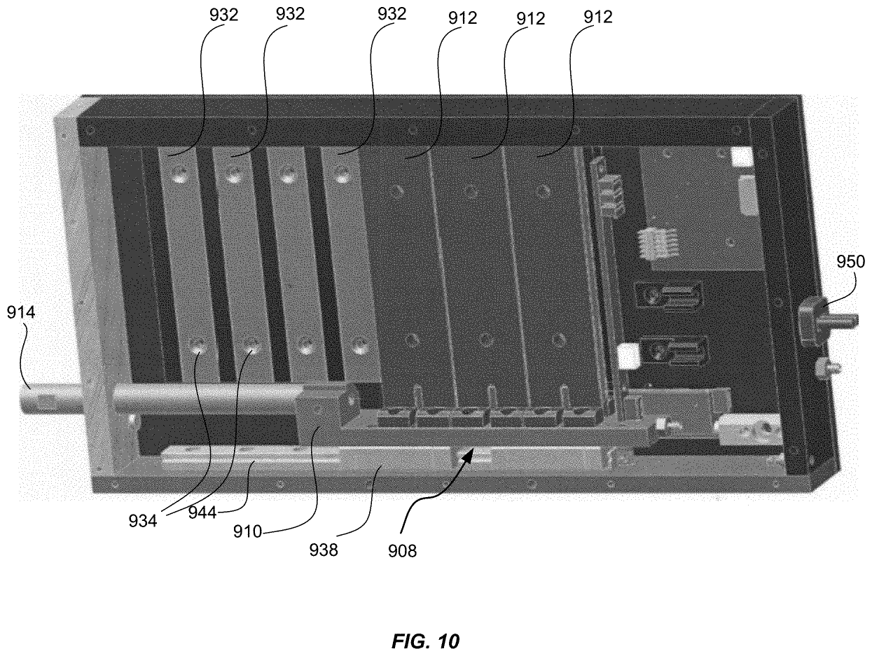

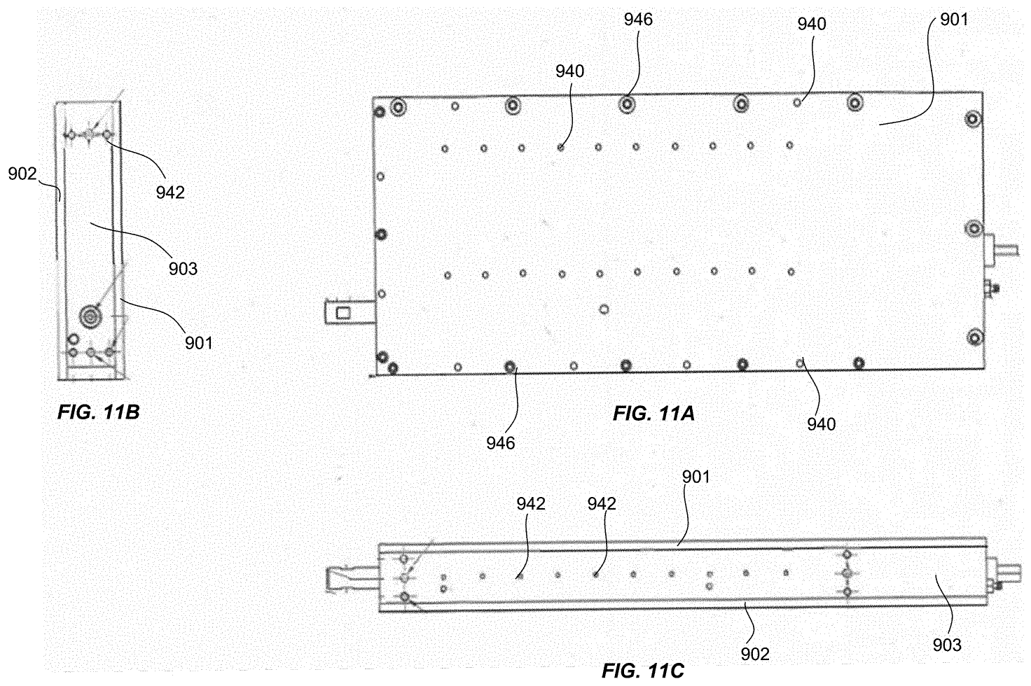

Attention is now directed to FIGS. 9-11, which depict a modular linear actuator 900 capable of being inexpensively implemented using a magnet housing 930 lacking milled surfaces. In FIGS. 9 and 10, which are partially transparent perspective views of the linear actuator 900, a first plate 901 (FIG. 11) of the magnet housing 930 has been cut away to reveal an interior chamber of the modular linear actuator 900. The magnet housing 930 may include a second plate 902 defining threaded and unthreaded holes (not shown in FIG. 9) for receiving screws used in joining a set of four side members 903 to the second plate 902. The second plate 902, the set of four side members 903, and the first plate (not shown) collectively enclose the interior chamber of the modular linear actuator 900.

In the embodiment of FIGS. 9 and 10, a first set of planar magnets 904 includes screw holes 906 to facilitate mounting of the first set of planar magnets 904 to the first plate 901 (not shown) of magnet housing 930 using screws. In FIG. 10, the first set of thin planar magnets 904 are not shown in order to reveal coil bobbins 912 and a second set of planar magnets 932. As shown, the planar magnets 932 each include screw holes 934 for facilitating attachment of the planar magnets 932 to the second plate 902 of the magnet housing 930 using screws.

FIGS. 11A, 11B and 11C respectively provide external views of top, side and end views of the linear actuator 900. As shown in FIGS. 11A-11C, the first plate 901 defines a first plurality of screw holes 940 and the side members 903 define a second plurality of screw holes 942 enabling the side members 903 to be secured to the first plate 901 using screws 946. The screw holes 940 and 942 also facilitate the attachment of magnets and other components within the interior chamber of the housing 930 without requiring the milling of recesses or the like into the first plate 901 or the second plate 902 in order to facilitate mounting of such components. The first plate 901 and the second plate 902 of the magnet housing 930 may be comprised of steel and may be inexpensively manufactured without utilizing milling or the like to create recesses or other surface features.

Referring again to FIGS. 9 and 10, the housing 130 and the magnets 904 and 932 combine to form what is referred to as a magnetic circuit. In one embodiment the housing 930 serves as magnet circuit steel providing return lines to interconnect the magnets 904 and 932 of the magnetic circuit and to help contour the magnetic field. Previous actuator designs have utilized a separate interior housing to support magnets. In contrast, the linear actuator 900 uses only the housing 930 to mount the magnets.

The housing 930 may combine the magnet circuit steel with a section holding a movable assembly 908 comprised of, for example, a piston 910, the coil bobbins 912 and a shaft 914. The movable assembly 908 may also include a flexible cable (not shown) connected to coil bobbins 912 and a linear encoder scale (not shown). The configuration of the movable assembly 908 may advantageously reduce the number of parts and reduce manufacturing costs. In one embodiment the coil bobbins 912 may be plastic molded. The coil bobbins 912 and shaft 914 may be connected to the piston 910 prior to assembly and a combined unit comprised of piston 910 and bobbin 912 of the movable assembly 908 is attached to the linear guide 938 using screws. The coil bobbins 912 are flat coils with the coil windings parallel to the travel of the piston 910 on the linear guide 938. Previous electromagnetic actuators have used coils where the windings were at right angles to the direction of travel. By utilizing flat coils, the thickness of the linear actuator 900 may be reduced. For example, in one embodiment the linear actuator 900 with flat coils can be 8 mm thick or even less, thereby being small enough to be used for placing electronic parts where pitch between electronic parts can be 8 mm. The piston 910 can be configured to mount at least two or three coil bobbins 912. By providing options for 2 coil or 3 coil versions, the linear actuator 900 can be controlled using either a single-pole or multi-pole controller as described below.

Housing 930 may also define a machined channel for receiving a rail 944 on which the linear guide 938 is slidably mounted. The channel may include a datum location and the rail 942 may positioned in relation to this datum location. In one embodiment linear guide 938 comprises a commercially available linear guide such as, for example, a standard linear guide manufactured by IKO®. A cable assembly 954 may be configured to receive an interface cable.

Piston 910 may be injection molded from machinable plastic or be made out of aluminum, either by using a casting mold or being extruded. The front edge and bottom edge of the piston 910 are machined precisely since these two surfaces control the position of the piston 910 relative to the datum location when the piston 910 is mounted on the linear guide 938 and the rail 944 is mounted in relation to the datum location. The piston 910 may be configured to provide mounting positions to accommodate one, two, three or more coil bobbins 912 The piston 910 may be made out of injection molded plastic. The piston 910 may also include screw holes in order to facilitate its mounting on the linear guide 938 using screws. The plastic of the piston 910 may be machined to conform to the top surface of the linear guide 938. In contrast to plastic, aluminum pistons often increase the friction experienced by linear guides by bending or otherwise deforming the walls of such guides, thereby potentially reducing expected life. Thus, the use of a plastic-molded piston 910 may further prolong useful lifetime of embodiments of the linear actuator 900.

Employing at least one coil bobbin 912 in lieu of the free standing coils typically used in small disc drive type electromagnetic actuators may advantageously reduce manufacturing time and avoid the need to glue coils into place.

In the embodiment the shaft 914 is illustrated as a vacuum shaft, but in other variations the shaft 914 is solid. When shaft 914 comprises a vacuum shaft, a hole may be cut through the center of the shaft for vacuum pick up. Thru shaft vacuum port 918 and a thru shaft vacuum conduit or the like (not shown) coupled to the shaft 914 may facilitate vacuum pick up. A compression spring (not shown) may be mounted between the piston 910 and an interior surface of side member 903B to return the piston 910 to a retracted position once power is cut or to counter balance a weight if the unit is mounted vertically, for example.

Piston 110 may also have a flex cable (not shown) for controlling various functions of the linear actuator 900. For example, the flex cable may be used to provide power to the coils of the coil bobbins 912 or to facilitate communication between cable assembly 954 and the coil so that, for example, an external controller can control the rate and positioning of the shaft 914. The cable assembly 954 includes a connector board configured to couple to external cable that may include about, for example, 16 lines in the cable.

The various components of linear actuator 900 may include apertures and for fixedly coupling different parts by use of screws, for example.

In addition, the simple design may mean that this actuator can be a viable replacement for pneumatic slides because the expected ten times greater cycle life more than offsets the cost to the customer of less than or equal to twice that of a pneumatic actuator.

Pneumatic slides currently represent about 20% of the total yearly sales of pneumatic electromagnetic actuators. The low-cost, long-life development described advantageously enables customers to improve the quality of their machines both in terms of work done and mean time between failures.

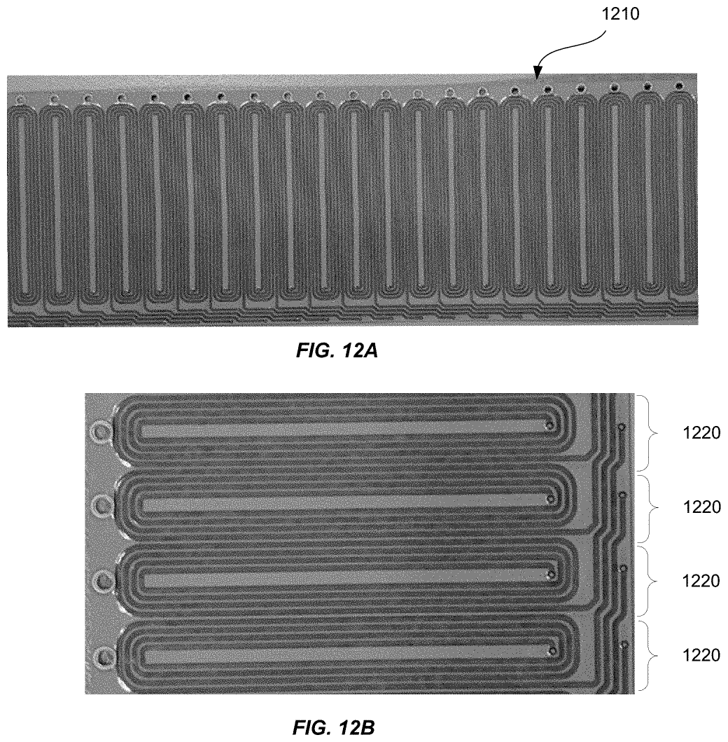

FIG. 12A illustrates a printed coil 1210 that can be used in the actuator 900 in lieu of the coil bobbins 912. FIG. 12B illustrates a set of coil portions 1220 of the printed coil 1210 in greater detail. In other embodiment the coil bobbins 912 within the actuator 900 may be replaced by an implementation of the multilayer printed coil arrangement 600.

Various changes and modifications to the present disclosure will become apparent to those skilled in the art. Such changes and modifications are to be understood as being included within the scope of the present disclosure. The various embodiments of the invention should be understood that they have been presented by way of example only, and not by way of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to”, or other like phrases in some instances shall not be read to mean that the narrower case is intended or required in instances where such broadening phrases may be absent.

The word “exemplary” is used herein to mean “serving as an example or illustration.” Any aspect or design described herein as “exemplary” is not necessarily to be construed as preferred or advantageous over other aspects or designs.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented. Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

In conclusion, the present invention provides, among other things, reduced-diameter linear electromagnetic actuators and reduced-cost methods of manufacturing those electromagnetic actuators. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosure as expressed in the claims.

What is claimed is:

1. A stacked actuator system, comprising:
a plurality of electromagnetic actuators, each of the plurality of electromagnetic actuators including a piston shaft;
a plurality of electrical connectors;
a plurality of signal lines connected between the plurality of electromagnetic actuators and the plurality of electrical connectors;
a system housing at least partially defining an interior volume containing the plurality of electromagnetic actuators, the system housing including a plurality of apertures through which extends the piston shaft of each of the plurality of electromagnetic actuators; and
a controller disposed within the interior volume and connected to the plurality of electrical connectors.

2. The stacked actuator system of claim 1 further including a base platform element upon which are mounted the plurality of electromagnetic actuators and the system housing.

3. The stacked actuator system of claim 2 wherein each piston shaft is disposed to move between extended and retracted positions within a plane substantially parallel to a generally planar surface of the base platform element.

4. The stacked actuator system of claim 2 wherein the plurality of connectors are disposed on the base platform element between the plurality of electromagnetic actuators and the controller.

5. The stacked actuator system of claim 1 wherein each piston shaft comprises a vacuum shaft wherein each of the plurality of electromagnetic actuators includes a thru shaft vacuum fitting defining an aperture in communication with an interior of the vacuum shaft of the actuator.

6. The stacked actuator system of claim 1 wherein at least one of the plurality of electromagnetic actuators includes:
an actuator housing including a first planar plate, a second planar plate and a plurality of side members attached to the first planar plate and the second planar plate;
a first plurality of magnets secured to the first planar plate;
a second plurality of magnets secured to the second planar plate.

7. The stacked actuator system of claim 6 further including a piston assembly positioned at least partially within the actuator housing, the piston assembly including:
the piston shaft of the at least one of the plurality of electromagnetic actuators,
an arrangement of coils wherein ones of the coils are positioned between the first plurality of magnets and the second plurality of magnets during operation of the at least one of the plurality of electromagnetic actuators, and
a flex cable connected to the arrangement of coils.

8. The stacked actuator system of claim 6 further including a piston assembly positioned at least partially within the actuator housing, the piston assembly including:
the piston shaft of the at least one of the plurality of electromagnetic actuators, and
a flexible printed coil having a plurality of printed coil portions wherein ones of the printed coil portions are positioned between the first plurality of magnets and the second plurality of magnets during operation of the at least one of the plurality of electromagnetic actuators.

9. The stacked actuator of claim 8 wherein the flexible printed coil includes a multi-layer printed coil comprised of a stacked plurality of flexible insulating layers wherein each of the flexible insulating layers includes a printed coil on a first surface thereof and wherein the printed coils on the stacked plurality of insulating layers are electrically interconnected via through holes extending between the first surface and an opposing second surface of each of the plurality of insulating layers and wherein the multi-layer printed coil includes a first coil termination connected to an upper one of the printed coils and second coil termination connected to a lower one of the printed coils.

10. The stacked actuator of claim 9 further including a flex cable having first and second leads respectively connected to the first coil termination and the second coil termination.

11. The stacked actuator system of claim 1 wherein at least one of the plurality of electromagnetic actuators includes:
a base housing comprising at least one recess configured to restrain at least one magnet in three dimensions and a channel configured to receive a linear guide;
a top housing fixedly attached to the base housing, wherein the top housing comprises at least one recess configured to restrain another at least one magnet in three dimensions; and
a piston assembly comprising at least a multi-layer printed coil integrated with a flex cable, the piston shaft of the at least one of the plurality of electromagnetic actuators, and a linear encoder scale wherein the piston assembly is positioned between the base housing and the top housing.

12. A stacked actuator system, comprising:
a base platform element;
a plurality of electromagnetic actuators mounted on the base platform element, each of the plurality of electromagnetic actuators including a piston shaft;
a plurality of electrical connectors;
a plurality of signal lines connected between the plurality of electromagnetic actuators and the plurality a electrical connectors; and
a system housing mounted on the base platform element and defining an interior volume containing the plurality of electromagnetic actuators, the system housing including plurality of apertures through which extends the piston shaft of each of the plurality of electromagnetic actuators.

13. The stacked actuator system of claim 12, further including a controller mounted on the base platform element, the controller being disposed within the interior volume and connected to the plurality of electrical connectors.

14. The stacked actuator system of claim 1 further including a base platform element upon which are mounted the plurality of electromagnetic actuators and the system housing.

15. The stacked actuator system of claim 12 wherein each piston shaft is disposed to move between extended and retracted positions within a plane substantially parallel to a generally planar surface of the base platform element.

16. The stacked actuator system of claim 13 wherein the plurality of connectors are disposed on the base platform element between the plurality of electromagnetic actuators and the controller.

17. The stacked actuator system of claim 12 wherein each piston shaft comprises a vacuum shaft wherein each of the plurality of electromagnetic actuators includes a thru shaft vacuum fitting defining an aperture in communication with an interior of the vacuum shaft of the actuator.

18. The stacked actuator system of claim 12 wherein at least one of the plurality of electromagnetic actuators includes:
an actuator housing including a first planar plate, a second planar plate and a plurality of side members attached to the first plate and the second planar plate;
a first plurality of magnets secured to the first planar plate;
a second plurality of magnets secured to the second planar plate.

19. The stacked actuator system of claim 18 further including a piston assembly positioned at least partially within the actuator housing, the piston assembly including:
the piston shaft of the at least one of the plurality of electromagnetic actuators,
an arrangement of coils wherein ones of the coils are positioned between the first plurality of magnets and the second plurality of magnets during operation of the at least one of the plurality of electromagnetic actuators, and
a flex cable connected to the arrangement of coils.

20. The stacked actuator system of claim 18 further including a piston assembly positioned at least partially within the actuator housing, the piston assembly including:
the piston shaft of the at least one of the plurality of electromagnetic actuators, and
a flexible printed coil having a plurality of printed coil portions wherein ones of the printed coil portions are positioned between the first plurality of magnets and the second plurality of magnets during operation of the at least one of the plurality of electromagnetic actuators.
